(19) United States
(12) Patent Application Publication
(10) Pub. No.: US 2022/0403537 A1
(43) Pub. Date: Dec. 22, 2022

(54) DEVICE FOR SUCTION AND RECOVERY OF ANODIC SLUDGE

(71) Applicant: CONSULTORIAS Y SERVICIOS MINEROS INTEGRALES LIMITADA, Copiapo (CL)

(72) Inventor: Eladio ROJAS VÉLIZ, Santiago (CL)

(21) Appl. No.: 17/807,263

(22) Filed: Jun. 16, 2022

(30) Foreign Application Priority Data
Jun. 16, 2021 (CL) 202101598

(51) Int. Cl. C25C 7/06; B01D 29/085; B01D 29/13; B01D 29/60; B01D 29/94; B01D 29/90; B01D 35/02

(52) U.S. Cl. CPC C25C 7/06; B01D 29/085; B01D 29/13; B01D 29/60; B01D 29/94; B01D 29/90; B01D 35/02; B01D 2201/204

(57) ABSTRACT

Equipment for sucking and extracting anodic sludge from cells for electro-refining or electro-winning of metals that allows the continuous and selective extraction of anodic sludge without interrupting electro-refining or electro-winning, preventing the anodic sludge from causing contamination in the copper cathodes and in the time in later stages of metal recovery, where the equipment comprises: a vacuum tank (2) that receives the extracted anode sludge, comprising an outlet valve (21) located in its lower part; a filter (25) resistant to acid (25) inside the vacuum tank (2) for the separation of the anode sludge from the sucked electrolyte so that the anode sludge remains in the filter (25) by a decantation process while the electrolyte passes to the lower part of the tank body; a vacuum system (3), connected to the vacuum tank (2), which generates a vacuum inside the vacuum tank (2) to generate the suction or vacuum aspiration of the equipment; and an anode sludge collector (1) comprising a transparent tube (11) where a first end (12) has a suction nozzle (14) connected, through which the anode sludge enters, and a second end (13) is connected to the vacuum tank (2); a regulating valve (15) mounted at or near said outlet end (13) of the transparent tube (11), which is in communication with the interior of the transparent tube (11) at one of its ends and at atmospheric pressure at the another end, where said regulating valve (15) allows the regulation of the suction pressure inside the anode mud collector (1) and the extraction generated in the suction nozzle (14).

### TECHNICAL FIELD

The invention is developed in the field of equipment to remove anodic sludge that forms in the processes of electro-refining or electro-obtaining copper, specifically it refers to equipment to suck and recover anodic sludge deposited at the bottom of copper cells. electrowinning without interrupting the electrorefining or electrowinning process.

### PRIOR ART DESCRIPTION

Anode sludge is a by-product that is generated during copper electro-refining processes and in the copper electro-winning process and contains insoluble elements from the anodes.

This by-product is a pulp of variable composition due to the different minor elements that make up the sulphide minerals or the composition of the materials used to produce anodes.

During the electro-refining or electro-winning process, elements are generated that do not dissolve in the copper or lead anodes, which decant and settle or accumulate at the bottom of the cells. Said elements that settle at the bottom of the cells form what is called anodic mud.

Traditionally, the anode sludge is extracted or collected through pipes that are connected in the lower part of the cells to be subsequently sent to a leaching plant for the case of the electro-refining process, where metals and other elements are extracted. chemicals that are of commercial interest or the anodic sludge from the electrowinning process are stored in drums to be recycled later and obtain new lead alloy anodes.

For the electro-refining process, the extraction of anode mud is carried out at the end of the copper anode dissolution process. The tasks associated with the renovation of the copper anodes are to electrically isolate the cells, remove the cathodes (mother plates) and worn anodes (anode scrap), discharge the electrolyte through a side cap of the cells and finally discharge the anode mud together with the remaining electrolyte by a cell floor plug.

For the copper electrowinning process, the removal of anodic sludge (lead oxide or sulfate) from the bottom of the cells is carried out every four to six months. The objective is that the cathodes to be obtained are not contaminated by the presence of accumulated anode sludge at the bottom of the cells. The current procedure for removing anodic sludge from the cells is to lower the current of the cell circuit, place a copper frame to make a by-pass of the current of the cells that are to be intervened (3 or 4 cells), extract the cathodes (mother plates) and lead anodes (lead alloy) of the cells to be intervened, the electrolyte is emptied through a side plug, the last remaining electrolyte is discharged through a floor plug and finally the anode mud is removed with operators by means of shovels and buckets that are later transported by the overhead crane of the electro-winning warehouse to a warehouse for temporary storage.

Therefore, equipment is necessary that allows the suction and selective extraction of the anodic sludge that is deposited at the bottom of the cells without interrupting the continuity of the process, mainly the electrowinning process, in order to prevent the anodic sludge from cause contamination of the copper cathodes and at the same time that the operators do not come into contact with the lead oxide that is a contaminant harmful to health.

In the state of the art, different equipment or devices have been described for the extraction of anodic sludge.

In this regard, document CN203474911 can be cited, which describes a device for extracting anodic sludge from the bottom of the cells in the zinc electro-refining process by means of a mobile car system that feeds fixed pipes on the edges of said tanks, where Said trolley system slides on the bottom of the ponds to extract the mud. One problem with this solution is that it requires the installation of a mobile cart that sucks the anode sludge from the bottom of the cell, which makes it difficult to carry out the extraction process.

Another document that can be considered is CN202220210, which describes a device for collecting the anode sludge at the bottom of an electrolytic cell comprising a vertical tube fixed to the wall of the electrolytic cell where the end near the bottom of the cell has a elbow with a horizontal tube with perforations and the other end of the vertical tube is connected to a pump that generates pumping to extract the anodic mud through the perforations of the horizontal tube and elbow. One problem with this solution is that the device is installed in a fixed position, therefore, depending on the size of the cell, it will be necessary to install multiple devices on the cell walls to ensure proper extraction of the anode mud deposited on the bottom. of the cell.

Document CL200202806 can also be considered, which describes a suction and filtering system for sludge from the bottom of electrolytic cells that allows said sludge to be removed without disassembling the cell electrodes and interrupting the service in which an extraction manifold is used for suction of the sludge connected to a pumping system that can be made up of any type of pump that meets the required extraction parameters. The extraction manifold is attached to a sight glass that allows a system operator to verify the effectiveness of the cleaning. The extraction of the manifold is given by the line of the pumping system. One problem with this solution is that the extraction of the manifold is determined by an impulsion pumping system where the removal is not generated by vacuum, where said removal is regulated by the operation of the pumps that make it difficult to vary the extraction flow in time. real for an operator who handles the extraction manifold when cleaning, so a selective removal of the sludge is not ensured.

Finally, utility model CL201702841, in the name of the applicant, should also be considered, which discloses a transportable suction machine for acid, organic or pulp liquids that allows suction of said liquids over a long distance through a suction tube connected to a vacuum tank by means of a flexible hose, where the vacuum tank includes a conical filter with mesh to filter solids and an outlet valve to discharge liquids using a pump connected to said valve, in addition said vacuum tank is connected to an external vacuum generator unit that It allows to suck liquids at a great distance. One problem with this solution is that it does not allow the selective suction of solids present in the liquids, since it is not possible to regulate the suction in real time by an operator who manipulates the suction tube, together with this, it does not include means to verify the proper removal of anode sludge.

None of the above documents teaches equipment such as that of the invention that allows vacuum suction and selective recovery of anodic sludge from electro-refining or electro-winning cells in a manual and simple manner that is easy to install and in simultaneous operation with said processes.

### SUMMARY

The invention relates to an equipment for sucking, by means of vacuum, and extracting anodic sludge from cells for electro-refining or electro-winning of metals. The purpose of the equipment is to extract anodic sludge continuously and simultaneously with the operation of the cells, without interrupting the process, being designed for the selective extraction of the anodic sludge deposited between the electrodes of said cells, preventing the anodic sludge from causing contamination in copper cathodes and at the same time in later stages of metal recovery generating contamination, for example, in the solvent extraction process

Another objective of the invention is to reduce the risks of accidents due to contact of the anode sludge with the operators in charge of extracting the anode sludge manually or by means of pneumatic pumps.

Another objective of the invention is to reduce the amount of electrolyte extracted from the cell during the suction of the anodic mud.

The equipment for sucking and recovering anodic sludge comprising an anodic sludge recoverer, for the extraction of anodic sludge, connected to a vacuum tank with a lid on its upper part with two connections and a lower valve, said tank being connected to a system powerful vacuum that generates the necessary suction for the extraction of anodic mud. The vacuum tank has a filter inside that allows the anodic mud to be accumulated and disposed of for processing.

The anode sludge collector comprises a transparent tube with opposite ends, where a first inlet end is connected to a suction nozzle through which the anode sludge enters and a second outlet end is connected to said vacuum tank. In addition, at or near said outlet end of the transparent tube, a regulating valve is mounted that allows the regulation of the vacuum inside the anodic mud collector and, consequently, regulates the suction pressure inside the anodic mud collector. and the extraction generated to selectively suck the anode sludge.

The transparent tube of the anodic sludge collector is a transparent rigid tube that allows the equipment operator to verify, when the equipment is in operation, the content of the suctioned flow and to identify that the anodic sludge is adequately extracted from a cell.

### BRIEF DESCRIPTION OF THE FIGURES

FIG. 1 shows a general view of the equipment to suck up and recover anodic mud.

FIG. 2 shows a side view of the anodic mud collector.

FIG. 3 shows the use of extensions to increase the operating length of the anodic mud collector.

FIG. 4 shows a front inside view of the elements inside the vacuum tank of the equipment.

FIG. 5 shows an internal side view of the elements inside the vacuum tank of the equipment.

FIG. 6 shows the vacuum tank acid resistant filter.

### DETAILED DESCRIPTION OF THE INVENTION

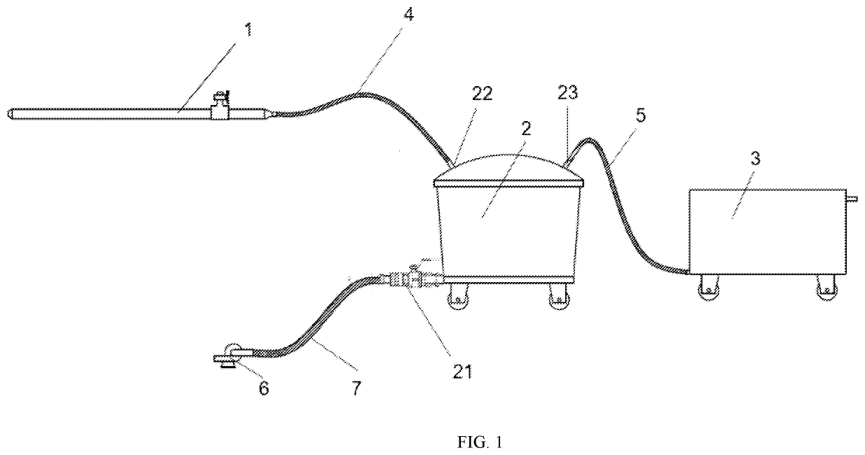

The present invention refers to an equipment for sucking and extracting anodic sludge from cells for electro-refining or electro-winning of metals, comprising, as shown in FIG. 1, an anodic sludge recuperator (1); a vacuum tank (2); a vacuum system (3); and flexible hoses (4, 5).

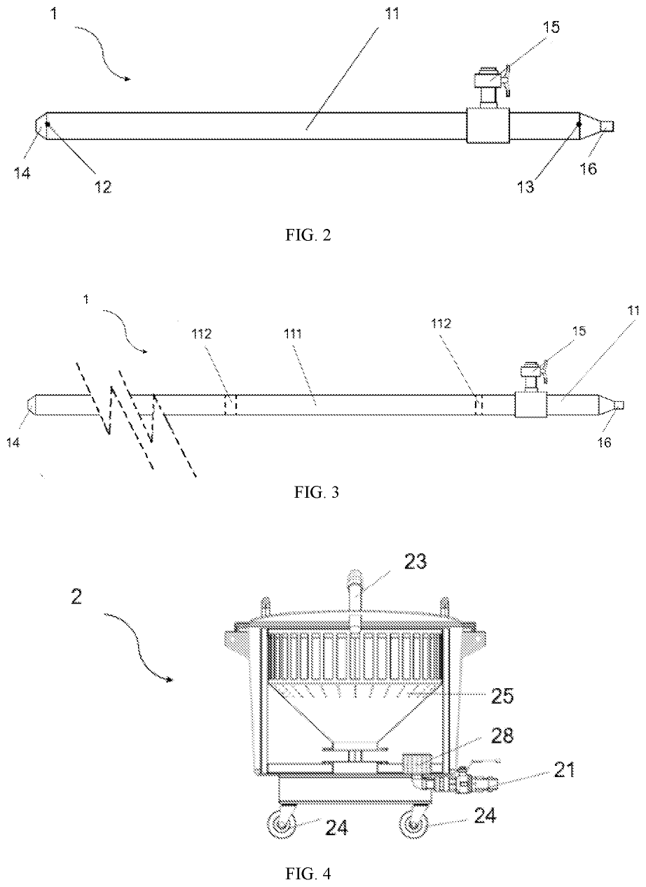

The anodic mud collector (1), as shown in FIG. 2, comprises a transparent tube (11) with opposite ends, where a first inlet end (12) has a suction nozzle (14) connected through it. which enters the anodic mud in the anodic mud collector (1), and a second outlet end (13) that is connected to the vacuum tank (2); a regulating valve (15) mounted on or near said outlet end (13) of the transparent tube (11), where the operator is located, which is in communication with the interior of the transparent tube (11) by one of its ends and at atmospheric pressure at the other end, where said regulating valve (15) allows, by means of its total or partial opening, the regulation of the vacuum inside the anodic mud recuperator (1) and, consequently, regulates the pressure of suction inside the anodic mud collector (1) and the extraction generated in the suction nozzle (14) to selectively suck the anodic mud. The transparent tube (11) further comprises a vacuum connector (16) at its second end (13) for connection to the vacuum tank (2).

The transparent tube (11) of the anodic sludge collector (1) is a transparent rigid tube that allows the equipment operator to verify, when the equipment is in operation, the content of the suctioned flow and to identify that the anodic sludge is adequately extracted from a cell. The transparent tube (11) has a diameter between 6.35 mm. (¼″) and 76.5 mm. (3″) preferably being 50.8 mm. (two″). The transparent tube (11), the suction nozzle (14), the regulating valve (15) and the vacuum connector (16) are made of a material resistant to acid and electrolyte from electro-refining or electro-winning processes.

The transparent tube (11) can be formed by a single tube or, optionally, as shown in FIG. 3, it can be formed by a plurality of sections of tube (111) connected by means of hermetic screwed joints (112) that allow adjust the length of the transparent tube (11) to the dimensions of the cell from which the anodic mud is extracted. The tube sections (111) can be of different lengths, so that new tube sections (111) of different lengths can be inserted and/or added to regulate the operating length of the transparent tube (11). Alternatively, when the transparent tube (11) is made up of a single tube, additional sections of tube (111) can be added to one of its ends (12, 13), connecting them by hermetic screwed joints (112), to increase its length.

Optionally, the anodic mud collector (1) further comprises a hose mounted outside the transparent tube (11), where the outlet end of said hose enters the tube (11) through a hole near the first end (12) said outlet end remaining inside the transparent tube (11). The hose is connected to a compressor to inject pressurized air inside the transparent tube (11), near the suction nozzle (14), to reduce the density of the suctioned mixture, generating turbulence that favors the extraction of anodic mud. by increasing the suction speed. The hole in the transparent tube (11) has a diameter equal to or similar to that of the hose that allows for proper adjustment of the latter, where a sealant is also included between the hose and the hole to prevent the penetration of air from the outside into the inside the transparent tube (11).

Said hose is made of a material resistant to acid and electrolyte from electro refining or electro obtaining processes. Alternatively, the hose for injection of pressurized air is mounted inside the transparent tube (11).

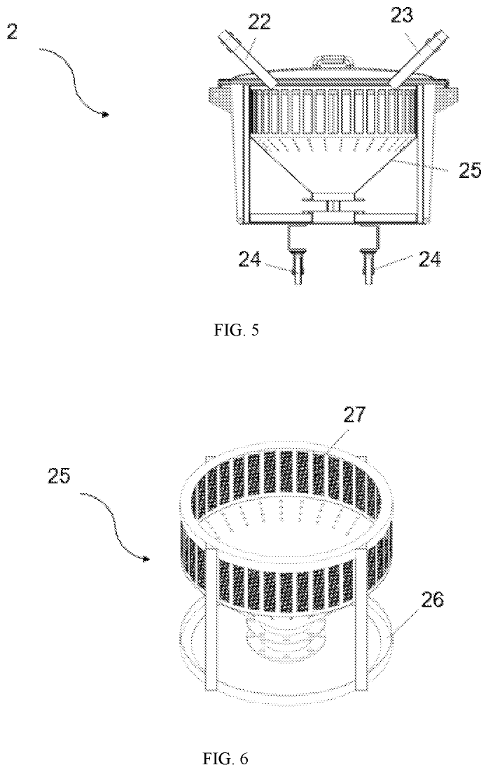

The vacuum tank (2) receives the anodic mud from the anodic mud collector (1), which sucks the anodic mud from the cells, comprising said vacuum tank (2), as shown in FIGS. 4 and 5, an outlet valve (21) located in its lower part; a top cap with a first top connection (22) and a second top connection (23); and a pond body. The top cover and the tank body are hermetically joined. The first upper connection (22) is connected by a flexible hose (4) to the anode mud collector (1), where said flexible hose (4) is connected to the vacuum connector (16) at the second end (13) of the tube transparent (11). The second upper connection (23) is connected by means of a flexible hose (5) to the vacuum system (3), where said system (3) generates the vacuum inside the vacuum tank (2) to generate suction or aspiration by means of vacuum in the anodic mud collector (1) through the flexible hose (4). For their part, the flexible hoses (4, 5) are made of a material resistant to acid and electrolyte from electro-refining or electro-obtaining processes. The vacuum tank (2) can include wheels (24) at its base to allow it to be moved during operation.

Inside the tank body there is an acid-resistant filter (25) that allows the filtration of the extracted solids, separating the anodic mud from the sucked electrolyte so that the anodic mud remains in the filter (25) through a decanting process while that the electrolyte passes to the lower part of the tank body. Preferably, the filter 25 includes a conical geometry with perforations. The acid-resistant filter (25), as shown in FIG. 6, is mounted on an acid-resistant lectern (26) resting on the bottom of the pond body, where the filter (25) is covered with a filter material (27), preferably a stainless steel mesh, which allows the filtering of solids, retaining the anodic mud and allowing the passage of liquids to the lower part of the tank body. In addition, the acid-resistant filter (25) includes ears or slings (not shown) in its upper part for its hooking and lifting, for its extraction from inside the vacuum tank (2) and transporting the anodic mud inside the tank. filter (25) to a storage area. The acid-resistant filter (25) includes a gate in its lower part that has a hinge mechanism and a closing mechanism inside, so that the anode sludge is discharged into a container for storage and subsequent processing, at open said gate at the bottom of the filter (25) by means of the hinge mechanisms by releasing the gate lock.

The outlet valve (21) is connected to the vacuum tank (2) by means of an acid resistant pipe that comes out from the lower part of the body of the vacuum tank (2), where said outlet valve (21) allows the evacuation of the filtered electrolyte. The evacuation of said electrolyte can be carried out by gravity or optionally with a pneumatic pump (6) connected to the outlet valve (21) by means of a flexible hose (7). Optionally, the acid resistant tubing includes a strainer (28) for filtering the electrolyte during pump or gravity evacuation. The flexible hose (7) is made of a material resistant to acid and electrolyte from electro-refining or electro-winning processes.

The vacuum system (3) is made up of a cubicle in which there are turbines or vacuum pumps inside that generate the appropriate vacuum levels for the operation of the system (3). Additionally, the vacuum system (3) includes a filter that prevents the passage of anode mud and electrolyte sucked into it, preventing possible damage. The vacuum system (3) can include wheels that allow it to be moved to the places of operation. The vacuum system (3) is of such power that it allows the suction of the anodic mud at a great distance from the cell, since it is possible to counteract the pressure losses that can be generated inside the flexible hose (4) that connects the anodic mud collector (1) and the vacuum tank (2) due to its length.

The equipment to suck and extract anodic mud from electro refining or electro obtaining cells operates by connecting the vacuum system (3) to the vacuum tank (2) through the flexible hose (5) in the second upper connection (23) of the cover upper part of the vacuum tank (2), in such a way as to achieve a suitable vacuum pressure to allow the suction of the anodic sludge through the anodic sludge collector (1).

For anodic sludge suction, the operator must partially introduce the anodic sludge collector (1) inside the cell, where the vacuum generated in the vacuum tank (2) produces suction in the anodic sludge collector (1).). The operator must place the suction nozzle (14) at the bottom of the cell to extract the anodic mud, verifying its correct extraction by observing the content that passes through the transparent tube (11). During the operation of the equipment, the operator regulates the suction pressure of the anodic sludge collector (1) by opening or closing the regulating valve (15) until it is verified that mainly, selectively, anodic sludge is extracted from the cell, reducing thus the amount of electrolyte that is sucked with the equipment.

The electrolyte that is sucked together with the anode sludge is filtered in the vacuum tank (2) and can be stored in containers by being discharged by means of a flexible hose connected to the outlet of the pneumatic pump (6) or to be returned to the electro-refining or electro-winning process, transported to a later stage of decantation of solids or returned to the electrolyte tanks and/or recirculation of the processes.

1. A device for sucking and extracting anodic mud from cells for electro-refining or electro-winning of metals that allows the continuous and selective extraction of anodic mud without interrupting electro-refining or electro-winning, preventing the anodic mud from causing contamination in the copper cathodes already the same time in subsequent stages of metal recovery, the device comprising:
a vacuum tank (2) that receives the extracted anodic sludge, comprising an outlet valve (21) located in its lower part; a top cap with a first top connection (22) and a second top connection (23); a filter (25) resistant to acid (25) inside the vacuum tank (2) for the separation of the anode sludge from the sucked electrolyte so that the anode sludge remains in the filter (25) by a decantation process while the electrolyte passes to the lower part of the tank body, where said outlet valve (21) allows the evacuation of the filtered electrolyte;
a vacuum system (3), connected to the vacuum tank (2), which generates a vacuum inside the vacuum tank (2) to generate the suction or vacuum aspiration of the equipment; and
an anodic mud collector (1) comprising a transparent tube (11) with opposite ends, where a first inlet end (12) has a suction nozzle (14) connected, through which the anodic mud enters the anode mud recuperator (1), and a second outlet end (13) that is connected to the vacuum tank (2); a regulating valve (15) mounted on or near said outlet end (13) of the transparent tube (11), where the operator is located, which is in communication with the interior of the transparent tube (11) by one of its ends and at atmospheric pressure at the other end, where said regulating valve (15) allows, by means of its total or partial opening, the regulation of the vacuum inside the anodic mud recuperator (1) regulating the suction pressure inside the anodic mud collector (1) and the extraction generated in the suction nozzle (14).

2. The device according to claim 1, wherein the transparent tube (11) is a rigid tube with a diameter between 6.35 mm (¼″) and 76.5 mm (3″).

3. The device according to claim 1, wherein the transparent tube (11), the suction nozzle (14), the regulating valve (15) and the vacuum connector (16) are made of a material resistant to acid and electrolyte from electro-refining or electro-winning processes.

4. The device according to claim 1, wherein the transparent tube (11) is formed by a plurality of sections of tube (111) connected by hermetic screwed joints (112) that allow its length to be adjusted.

5. The device according to claim 1, wherein the transparent tube (11) also comprises additional sections of tube (111) connected at some of its ends, by hermetic screwed joints (112) that allow an increase of its length.

6. The device according to claim 1, further comprising a hose mounted on the outside of the transparent tube (11) and entering the tube (11) near the suction nozzle (14), said hose being connected to a compressor to inject pressurized air inside the transparent tube (11) to reduce the density of the suctioned mixture, generating turbulence that increases the suction speed.

7. The device according to claim 6, wherein the hose that injects pressurized air is made of a material resistant to acid and electrolyte from electro refining or electro obtaining processes.

8. The device according to claim 1, wherein the anodic mud collector (1) is connected to the first upper connection (22) of the vacuum tank (2) by a flexible hose (4).

9. The device according to claim 8, wherein the transparent tube (11) comprises a vacuum connector (16) at its second end (13) to connect the flexible hose (4).

10. The device according to claim 1, wherein the vacuum system (3) is connected to the second upper connection (23) of the vacuum tank (2) by a flexible hose (5).

11. The device according to claim 9, wherein the flexible hoses (4, 5) are made of a material resistant to acid and electrolyte from electro refining or electro obtaining processes.

12. The device according to claim 1, wherein a pneumatic pump (6) is connected to the outlet valve (21) to evacuate the electrolyte from the vacuum tank (2).

13. The device according to claim 12, wherein the pneumatic pump (6) is connected to the outlet valve (21) by a flexible hose (7).

14. The device according to claim 13, wherein the flexible hose (7) is made of a material resistant to acid and electrolyte from electro refining or electro obtaining processes.

15. The device according to claim 12, wherein the output of the pneumatic pump (6) has a flexible hose connected to discharge the filtered electrolyte.

16. The device according to claim 1, wherein the vacuum system (3) is made up of a cubicle in which there are turbines or vacuum pumps and air filters.

17. The device according to claim 1, wherein the acid-resistant filter (25) comprises a conical geometry with perforations, being covered with a filter material (27) and a gate with a hinge mechanism and a mechanism closure for the discharge of the anodic mud stored in the filter (25).

18. The device according to claim 17, wherein the filter material (27) is a stainless steel mesh.

19. The device according to claim 17, wherein the filter (25) includes ears or slings in its upper part for its hooking and lifting for its extraction from inside the vacuum tank (2).
